(19) United States
(12) Patent Application Publication
(10) Pub. No.: US 2018/0364790 A1
(43) Pub. Date: Dec. 20, 2018

(54) CONTENT CONTROL SENSING IN AUGMENTED REALITY OR VIRUTAL REALITY VIEWER

(71) Applicant: UVIAUS, LLC, Seattle, WA (US)

(72) Inventors: Jaycen Thorgeirson, Vashon, WA (US); Zachary A. Shomler, Carnation, WA (US); Cody Rayne Downes, Seattle, WA (US)

(21) Appl. No.: 15/904,712

(22) Filed: Feb. 26, 2018

Related U.S. Application Data
(60) Provisional application No. 62/522,008, filed on Jun. 19, 2017.

(51) Int. Cl. G06F 1/32; G06T 19/00; G02B 27/01; G01V 8/10

(52) U.S. Cl. CPC G06F 1/3265; G06F 1/3287; G01V 8/10; H04N 13/044; G02B 27/017; G06T 19/006

(57) ABSTRACT

A viewer includes a display, processing logic, memory, and a sensor configured to output a sense signal. Video content associated with a virtual reality or augmented reality experience is stored in the memory. The processing logic is configured to automatically render the video content to the display when the sense signal indicates that the viewer has been brought to a face of a user.

### CROSS-REFERENCE TO RELATED APPLICATIONS

This application claims priority to U.S. provisional Application No. 62/522,008 filed Jun. 19, 2017, which is hereby incorporated by reference.

### BACKGROUND INFORMATION

Virtual reality (VR) and augmented reality (AR) experiences generally include headsets that can be worn on or about the head. The headsets are commonly referred to as a Head Mounted Display (HMD) that includes a display to present AR or VR content to a wearer of the HMD. Generally, a user utilizes one or more straps to secure the HMD to their head and wires to power the HMD or deliver AR or VR content may also be required. Subsequently, a user may navigate through menus to initiate a particular AR or VR experience. Hence, there are physical and time barriers to AR and VR experiences in conventional HMDs.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified.

FIG. 1A includes two views of an example viewer for viewing augmented reality and/or virtual reality video content, in accordance with an embodiment of the disclosure.

FIG. 1B includes an example viewer for viewing augmented reality and/or virtual reality video content that includes example sensors at a gripping surface and a face interface edge of the viewer, in accordance with an embodiment of the disclosure.

FIG. 2 illustrates an example viewer that includes a display, in accordance with an embodiment of the disclosure.

FIG. 3 illustrates a container for holding a viewer, in accordance with an embodiment of the disclosure.

FIGS. 4A and 4B include four different views of an example viewer, in accordance with an embodiment of the disclosure.

FIG. 5 illustrates a block diagram representation of example hardware that may be included in a viewer, in accordance with an embodiment of the disclosure.

FIG. 6 illustrates a flowchart of an example process of an automatic initiation of an augmented reality or virtual reality experience, in accordance with an embodiment of the disclosure.

FIGS. 7A and 7B illustrate an example viewer including an optical sensor for initiating an augmented reality or virtual reality experience, in accordance with an embodiment of the disclosure.

FIGS. 7C and 7D illustrate cross section views of the example viewer illustrated in FIGS. 7A and 7B, in accordance with an embodiment of the disclosure.

### DETAILED DESCRIPTION

Embodiments of a system, apparatus, and method for controlling an experience in an Augmented Reality (AR) or Virtual Reality (VR) are described herein. In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Throughout this specification, several terms of art are used. These terms are to take on their ordinary meaning in the art from which they come, unless specifically defined herein or the context of their use would clearly suggest otherwise.

In this disclosure, the term “viewer” includes virtual reality (VR) and augmented reality (AR) headsets that can be worn on or about the head that may be commonly referred to as a Head Mounted Display (HMD). For the purposes of this disclosure, the term viewer also includes AR and/or VR viewers that includes a display that a user holds up to his or her face and eye to view an AR or VR experience, even though the viewer may not be “mounted” to the head of a user. One example of a commercially available “viewer” is Google Cardboard from Google, Inc. of Mountain View, Calif.

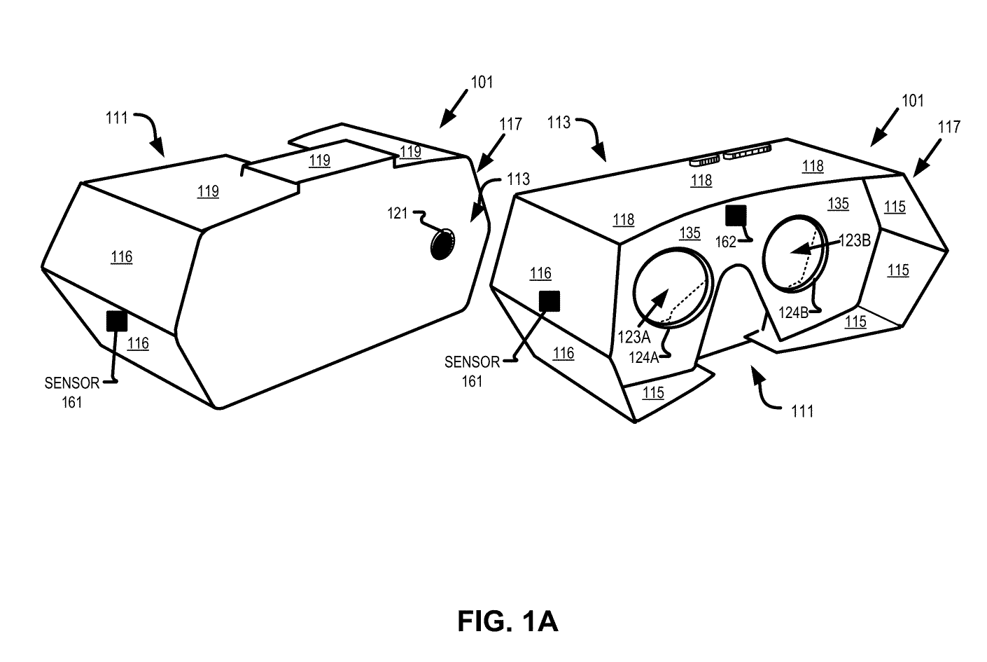

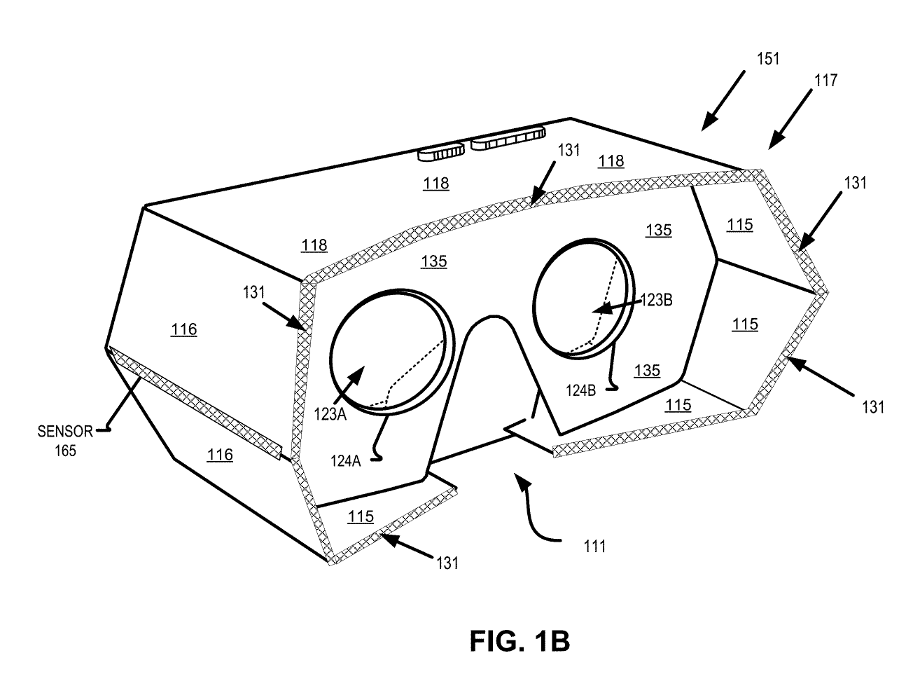

FIG. 1A includes two views of an example viewer 101 for viewing augmented reality and/or virtual reality video content, in accordance with an embodiment of the disclosure. Viewer 101 includes a viewing body that includes a scene side 113 opposite a viewing side 111 of the viewing body. A left hand surface 116 and a right hand surface 117 of the viewer body are disposed between the scene side 113 and the viewing side 111. Left hand surface 116 and right hand surface 117 are shaped for a user to grasp viewer 101 to bring the viewer 101 to the user's eyes, in the illustrated embodiment of FIG. 1A. Left hand surface 116 is disposed opposite of right hand surface 117. The viewer body also includes a bottom surface 119 disposed opposite top surface 118. In the illustrated embodiment, a cutout 121 on scene side 113 allows ambient scene light into the viewing body. An image sensor may be disposed to receive the ambient scene light through the cutout 121. The image sensor may be configured to capture images and the images may be combined with augmented reality content and rendered to a display included in the viewer 101 to facilitate augmented reality.

A viewing cavity defined by surfaces 115 and viewing surface 135 is disposed on the viewing side 111 of the viewer body, in the illustrated embodiment of FIG. 1A. The viewing cavity generally allows a user to create a dark viewing cavity around their eyes when the viewer is raised to their face/eyes. Viewing optical elements 123A and 123B are included in the viewer 101 so that a user can look through cutouts 124A and 124B to focus on a display included in viewer 101. In one embodiment, viewing optical elements 123A and 123B include a bi-convex lens that generates a virtual image that can be focused on by a user of viewer 101.

FIG. 1A shows sensor 161 disposed proximate to the left hand surface 116. Another sensor (not illustrated) may be disposed proximate to the right hand surface 117. FIG. 1 also show sensor 162 on the viewing side 111 of viewer 101.

Sensor 161 is configured to generate a sense signal when a user's hand is detected grasping the viewer near left hand surface 116. A sensor disposed proximate to the right hand surface 117 may also generate a sense signal when a user's hand is detected grasping the viewer near right hand surface 117. Sensor 162 is configured to generate a sense signal when the viewing side 111 of viewer 101 has been brought to the face of the user of the viewer 101.

Sensor 161 may be a photosensitive element (e.g. photodiode), a proximity sensor, and/or a touch sensor. When sensor 161 includes a photosensitive element, a light measurement below a certain threshold may indicate a certain level of darkness that indicates that a user has grasped the viewer 101 near left hand surface 116 and consequently restricted the intensity of ambient light incident on the photosensitive element. Sensor 161 may be a proximity sensor that outputs a sense signal that indicates how close an object is. In one embodiment, an infrared proximity sensor that detects a closeness of an object that reflects an emitted infrared light back to an infrared detector of the proximity sensor. Hence, when an object is detected quite close to sensor 161, it may indicate that a user has grasped the viewer near left hand surface 116. Sensor 161 may be a resistive or capacitive touch sensor that generates a sense signal when it senses touch. Therefore, when a person grasps the viewer 101 on left hand surface 116, sensor 161 may generate a sense signal in response to being contacted by a user's hand. The sensor proximate to right hand surface 117 may operate similarly to the above examples of sensor 161.

Sensor 162 may include a photosensitive element (e.g. photodiode of image sensor) or proximity sensor. When sensor 162 includes a photosensitive element, a light measurement below a certain threshold may indicate a certain level of darkness that indicates that a user has brought the viewing side 111 of the viewer 101 to their face/eyes and consequently restricted the intensity of ambient light incident on the photosensitive element. Sensor 162 is disposed within the viewing cavity defined by surfaces 115 and viewing surface 135, in the illustrated embodiment. Sensor 162 may be a proximity sensor that outputs a sense signal that indicates how close an object is. In one embodiment, an infrared proximity sensor that detects a closeness of an object that reflects an emitted infrared light back to an infrared detector of the proximity sensor. Hence, when an object is detected quite close to sensor 162, it may indicate that a user has brought the viewing side 111 of viewer 101 to their face/eyes.

FIG. 1B includes an example viewer 151 for viewing augmented reality and/or virtual reality video content that includes example sensors at a gripping surface and a face interface edge of the viewer 151, in accordance with an embodiment of the disclosure. In FIG. 1B, sensor 165 shows one example placement of a touch-sensitive sensor on a gripping surface of viewer 151. Similarly, a touch-sensitive sensor 131 (either resistive or capacitive) may be disposed on a face interface edge that is included in a boundary of the viewing cavity defined by surfaces 115. In one embodiment, the touch-sensitive sensor on the face interface edge is included in a gasket that cushions the face of a user who has viewer 151 pressed against her forehead and/or eye area. Sensors 165 or 131 may be a resistive or capacitive touch sensor that generates a sense signal when it senses touch. Therefore, when a person raises the viewer 151 to their face/eyes, sensor 131 may generate a sense signal in response to being contacted by a user's forehead and/or cheeks. This sense signal may indicate that the viewer has been brought to the face of a user. Similarly, when a person raises the viewer 151 to their face/eyes, sensor 165 may generate a sense signal in response to being contacted by a user's hands. This sense signal may assist in indicating that the viewer has been brought to the face of a user. In addition to sensors 165 and 131, a motion sensor (e.g. accelerometer and/or gyroscope) may be included in viewer 101 to assist in determining if the viewer has been raised for viewing.

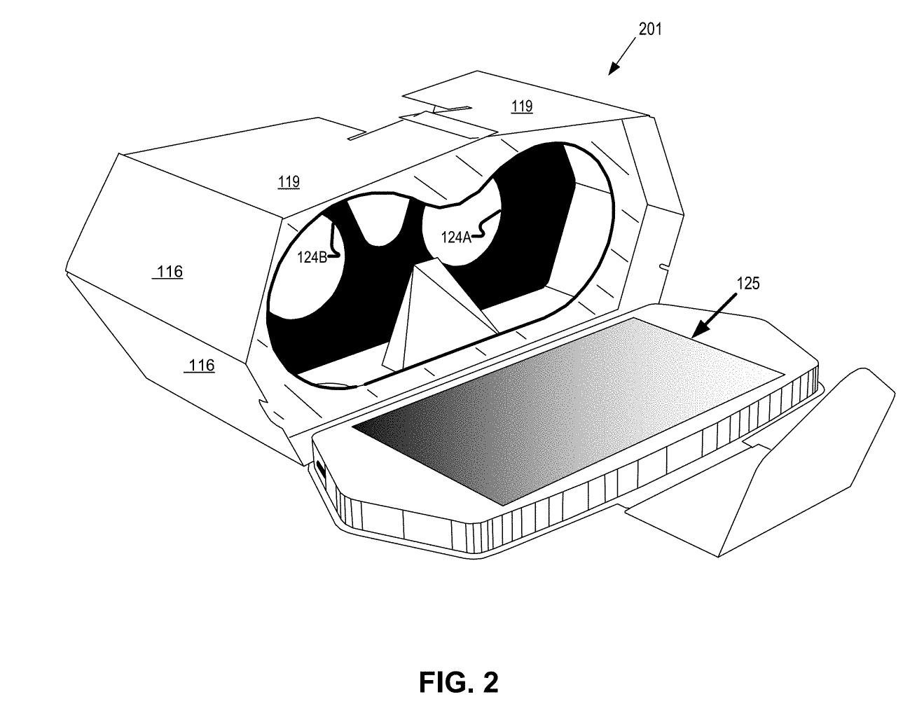

FIG. 2 illustrates an example viewer 201 that includes a display 125, in accordance with an embodiment of the disclosure. Display 125 is affixed to viewer 201, in the illustrated embodiment. Display 125 may be included in a mobile device (e.g. smartphone, tablet, or phablet) that can be inserted into and/or removed from viewer 201, in some embodiments. Display 125 can be folded into viewer 201 so that a user looking through the cutouts 124A and 124B and through optical elements (e.g. similar to 123A and 123B) of viewer 201 can view the display 125.

In some embodiments, display 125 is included in a device that functions independently of viewer 201 to facilitate AR experiences. The device may differ from a conventional mobile device (e.g. smartphones and tablets) in that it is a purpose-driven device that may deliver an experience associated with mechanical or ornamental features of the device. The device may be repurposed and reused within different designs of different viewing bodies of viewers.

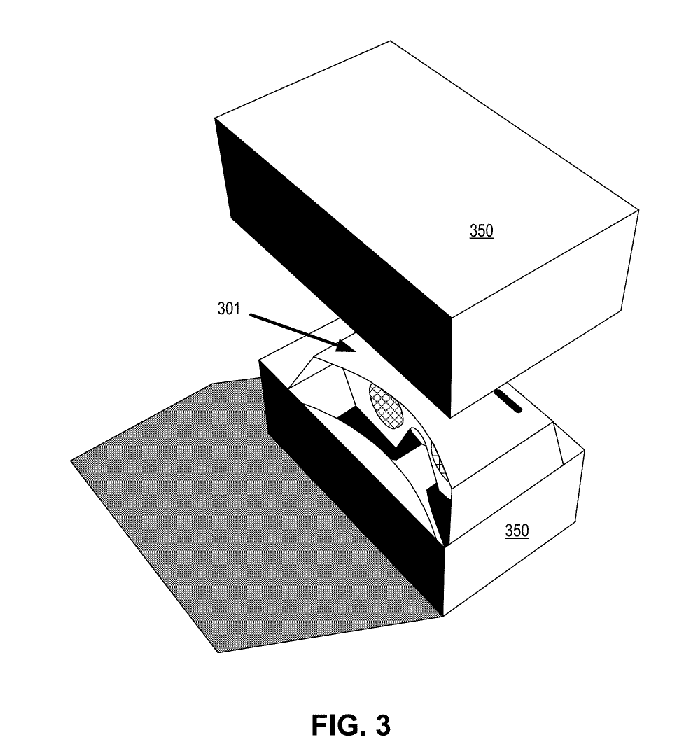

FIG. 3 illustrates a container 350 for holding a viewer 301, in accordance with an embodiment of the disclosure. In some contexts, the viewers described in this disclosure may be shipped or stored in a container 350 and after container 350 is opened, the viewer is activated to initiate AR or VR content based on the sensing techniques described in this disclosure.

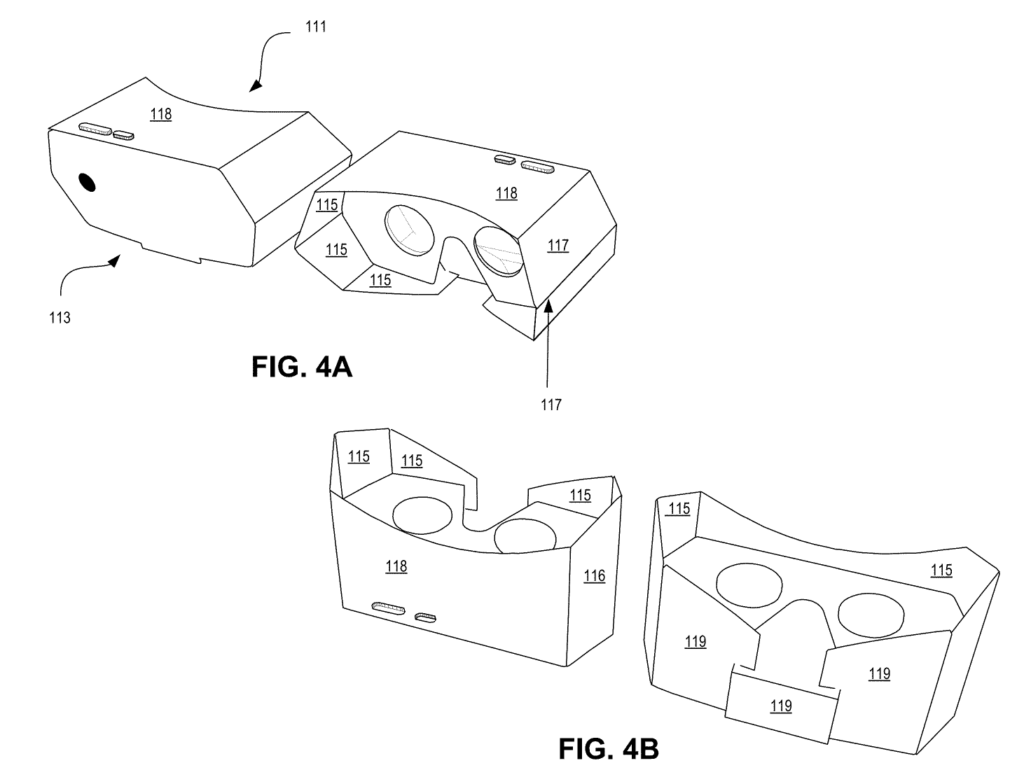

FIGS. 4A and 4B include four different views of an example viewer, in accordance with an embodiment of the disclosure. In FIG. 4A, the right hand surface 117 is visible, in contrast to FIG. 1A. FIG. 4B provides views of additional surfaces 115 of viewer 101.

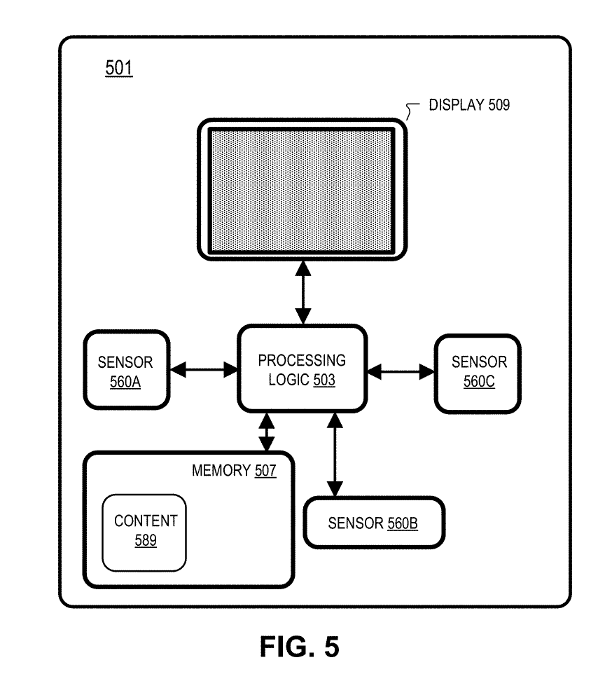

FIG. 5 illustrates a block diagram representation of example hardware that may be included in a viewer, in accordance with an embodiment of the disclosure. FIG. 1 illustrates a device 501 including processing logic 503, memory 507, display 509, and sensors 560, in accordance with embodiments of the disclosure. The viewers described in this disclosure may include the components of device 501. Display 509 may be positioned in a viewer to be viewed by a user of the viewer. Memory 507 is communicatively coupled to processing logic 503, in FIG. 5.

The term “processing logic” (e.g. 503) in this disclosure may include one or more processors, microprocessors, multi-core processors, and/or Field Programmable Gate Arrays (FPGAs) to execute operations disclosed herein. In some embodiments, memories (not illustrated) are integrated into the processing logic to store instructions to execute operations and/or store data. Processing logic may include analog or digital circuitry to perform the operations disclosed herein. A “memory” or “memories” (e.g. 507) described in this disclosure may include volatile or non-volatile memory architectures.

Memory 507 includes augmented reality or virtual reality video content 589, in FIG. 5. Content 589 may include AR or VR images such as video images and corresponding audio. Content 589 may include 360-degree photos or video. In one embodiment, content 589 includes interactive 3D images that are pre-loaded into memory 507. In one particular illustrative embodiment, multiple files including 3D environments of multiple real estate listings are included as content 589 for a viewer to view. Content 589 may be a link or access to streaming content stored on a remote server that can be accessed by a wireless radio (not illustrated) of device 501, in one embodiment. Memory 507 may also include instructions for execution by processing logic 503.

Processing logic 503 is communicatively coupled to receive sense signals from sensors 560A, 560B, and 560C. Processing logic 503 may include ADC(s) to assist in processing the sense signals where the sense signals are analog. In some embodiments, only sensor 560A is included in device 501. In some embodiments, only sensors 560A and 570B are included in device 501. In some embodiments, each of the sensors 560A, 560B, and 560C are included in device 501. There may be more than three sensors included in a viewer including device 501.

Device 501 is configured to determine when a user has brought a viewer to their eyes to view AR or VR content and then play content 589 for the user of the viewer. In some embodiments, all the user has to do to initiate the rendering of content 589 on display 509 is to bring a viewer including device 501 to their face and no other actions (e.g. button presses or eye tracking) are required to initiate content 589. The features of sensors 161, 162, 165, and/or 131 may be included in any of sensors 560A, 560B, and 560C.

In one embodiment, sensor 560A is an optical sensor disposed on left hand surface 116, sensor 560B is an optical sensor disposed on right hand surface 117, and sensor 560C is an optical sensor disposed to receive image light from the viewing cavity defined by surfaces 115. Content 589 may be displayed on display 509 when at least one of sensor 560A and 560B are darkened along with sensor 560C since a darkened viewing cavity and a darkened hand surface brings a strong likelihood that a user has brought the viewer including device 501 to their eyes. In some embodiments, when a sensor in the viewing cavity receives over a threshold amount of ambient light subsequent to being darkened, content 589 is paused because there is a strong likelihood that the user has removed a viewer including device 501 from their eyes. When the sensor in the viewing cavity is darkened again, the content 589 may be resumed since the viewer has likely brought the viewer including device 501 back to the eyes of the user. In some embodiments, processing logic 503 starts playing content 589 based on the optical sense signals from only one of the sensors 560 described in this paragraph.

In one embodiment, sensor 560A is a touch-sensitive sensor disposed on left hand surface 116, sensor 560B is a touch-sensitive sensor disposed on right hand surface 117, and sensor 560C is a touch-sensitive sensor disposed along a face interface edge of the viewing cavity defined by surfaces 115. Content 589 may be displayed on display 509 when at least one of sensor 560A and 560B are touched along with sensor 560C being touched since a touch on the edge of viewing cavity and a touched hand surface brings a strong likelihood that a user has brought the viewer including device 501 to their eyes. In some embodiments, when a sensor along the face interface edge of the viewing cavity loses touch contact, content 589 is paused because there is a strong likelihood that the user has removed a viewer including device 501 from their eyes. When the sensor along the face interface edge of the viewing cavity senses touch again, the content 589 may be resumed since the viewer has likely brought the viewer including device 501 back to the eyes of the user. In some embodiment, processing logic 503 starts playing content 589 based on the touch signals from only one of the sensors 560 described in this paragraph.

In some embodiments, device 501 includes touch sensor(s) on the hand surface 116 and/or 117 and an optical sensor receiving image light incident upon the viewing cavity defined by surfaces 115 and 135. In some embodiments, device 501 includes optical sensor(s) on the hand surface 116 and/or 117 and one or more touch sensors along the face interface edge of the viewing cavity defined by surfaces 115. In some embodiments, device 501 may include a motion sensor coupled to processing logic 503 (not illustrated) and initiating the content 589 may be based at least in part on measurements/readings from the motion sensor.

In some embodiments, a viewing body of the viewer is largely made out of a cardboard or foldable composite. The viewer may be intended for non-permanent use and large-scale distribution. As part of the large-scale distribution, it may be delivered or stored in a container such as container 350. Prior to the viewer sensing that the viewer has been brought to a face of a user to initiate content 589, the viewer may need to be activated by pressing a power button to power the device. In one embodiment, the viewer is activated when the viewer is removed from a magnetic field of a magnet included in container 350 and the viewer includes a magnetic field sensor (e.g. hall effect sensor) to detect the presence of the magnetic field from the magnet included in the container 350.

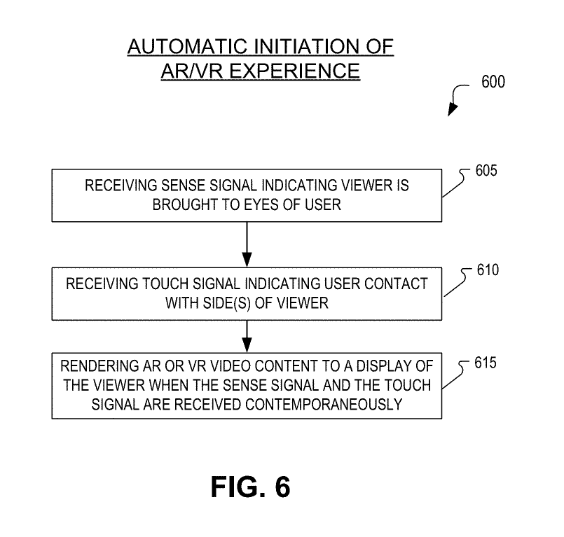

FIG. 6 illustrates a flowchart of an example process of an automatic initiation of an augmented reality or virtual reality experience, in accordance with an embodiment of the disclosure. The order in which some or all of the process blocks appear in process 600 should not be deemed limiting. Rather, one of ordinary skill in the art having the benefit of the present disclosure will understand that some of the process blocks may be executed in a variety of orders not illustrated, or even in parallel.

In process block 605, a sense signal is received by processing logic (e.g. 503). The sense signal indicates that a user has brought a viewing side (e.g. 111) of a viewer to the user's eyes. The sense signal is generated by a sensor included in the viewer.

In process block 610, a touch signal is received by the processing logic. The sense signal indicates that a user has touched the side of the viewer. The touch signal is generated by a touch-sensitive sensor disposed on a side (e.g. 116 or 117) of the viewer.

In process block 615, virtual reality or augmented reality video content (e.g. content 589) is rendered to a display of the viewer when the sense signal and the touch signal are received by the processing logic.

In one embodiment, the display, the processing logic, the memory, and the sensor of process 600 are included in a mobile device attached with the viewer.

In one embodiment, process 600 further includes pausing the rendering of the video content (e.g. 589) when the sense signal and the touch signal are no longer received by the processing logic contemporaneously.

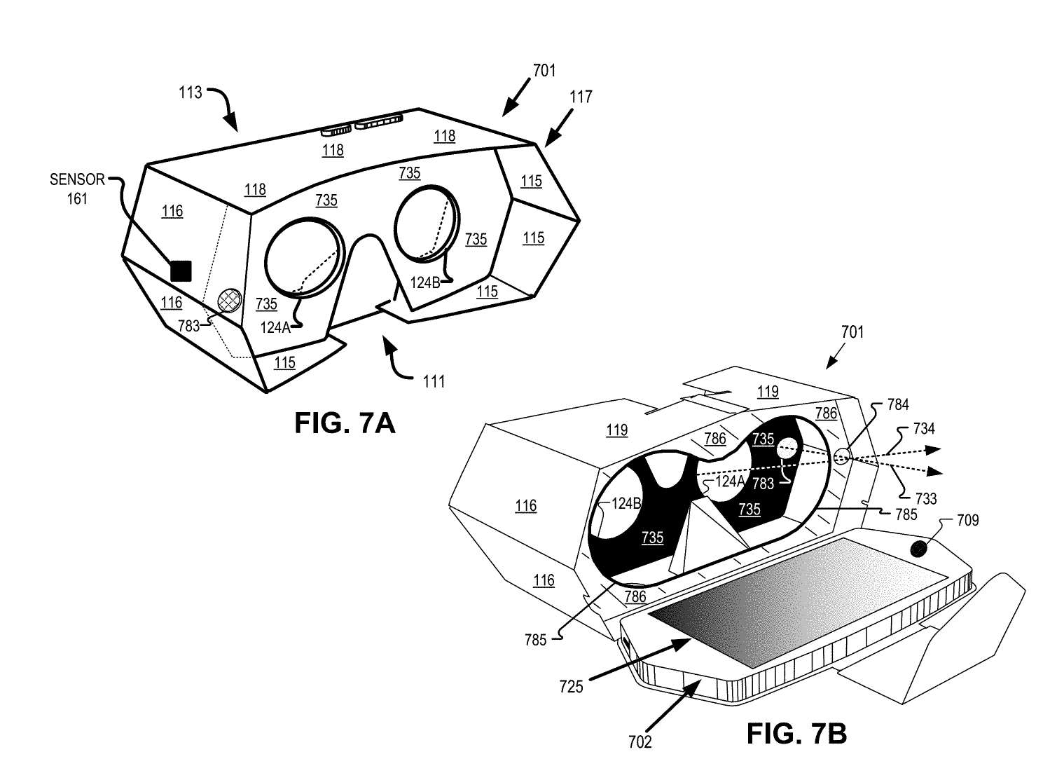

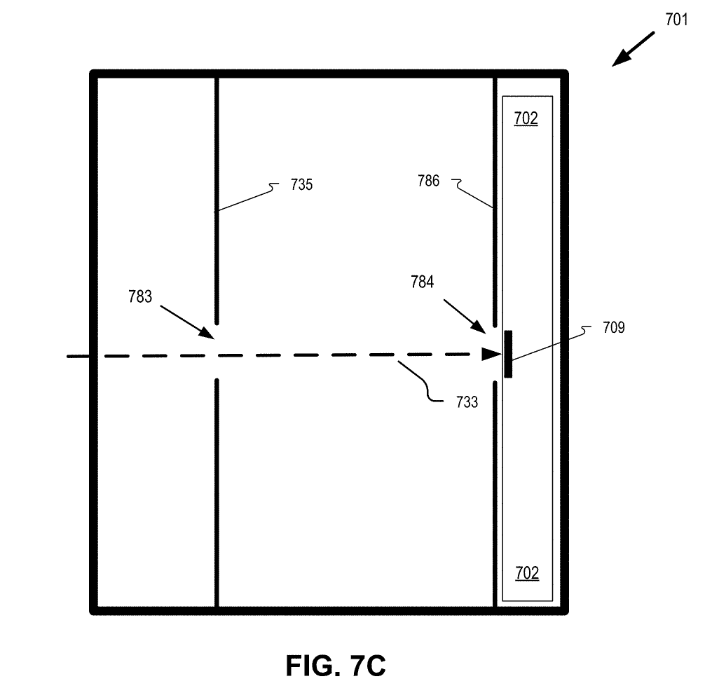

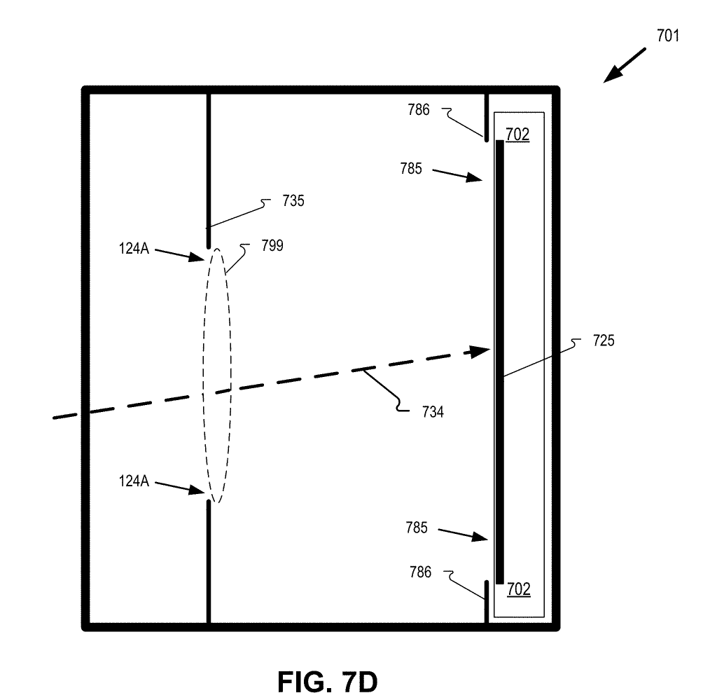

Therefore, in process 600, a touch-sensitive sensor is utilized on the side of the viewer (as described in process block 610) and either an optical sensor or a touch-sensitive sensor may be utilized in process block 605. In one embodiment, the sensor of process block 605 includes an infrared proximity sensor. In one embodiment, the sensor of process block 605 includes an image sensor (e.g. CMOS image sensor). When a touch-sensitive sensor is used as the sensor in process block 605, the touch-sensitive sensor may be disposed similar to sensor 131. When an optical sensor is used as the sensor in process block 605, the optical sensor may be disposed on the viewer similar to sensor 162 or sensor 709 described in connection with FIG. 7.

FIGS. 7A and 7B illustrate an example viewer 701 including an optical sensor 709 for initiating an augmented reality or virtual reality experience, in accordance with an embodiment of the disclosure. Viewer 701 includes a viewing surface 735 having a first eye-cutout 124A and a second eye-cutout 124B for a user to view the display 725. Lensing optics (e.g. bi-convex lenses) may be positioned so that a user of viewer 701 looks through the eye-cutouts 124 and the lensing optics to view display 725. FIGS. 7A and 7B illustrate a sensing cutout 783 included in viewing surface 735.

FIG. 7B illustrates a mobile device support surface 786 disposed on a parallel plane to the viewing surface 735. The mobile device support surface 786 may include a display void 785 that is larger than display 725 but smaller than mobile device 702 so that the display may be seen by a user but at least a portion of the mobile device 702 rests on (or is supported by) mobile device support surface 786. In FIG. 7B, a second sensing cutout 784 is included in mobile device support surface 786. When mobile device 702 is folded up into viewer 701, optical sensor 709 is disposed to receive image light through sensing cutout 783 and second sensing cutout 784 along light path 733. Optical sensor 709 may generate an image light value representing an intensity of the image light incident upon the optical sensor 709. Optical sensor 709 is one example of sensor(s) 560. In one illustrative example, optical sensor 709 is an image sensor. In one embodiment, the image sensor is included in a front-facing camera of a mobile device. An average pixel value of an image captured by the front-facing camera may be used to detect the intensity of image light incident upon the sensor 709. Processing logic of viewer 701 (e.g. 503) may receive the image light value from optical sensor 709. When the image light value reaches a pre-determined image light threshold, the processing logic may automatically render the content 589 to display 725 of viewer 701. The pre-determined image light threshold may be stored in memory, such as memory 507. In one particular illustrative example, processing logic automatically renders the content 589 to the display 725 when the image light value falls below the pre-determined image light threshold that is consistent with a user bringing the viewer 701 to their face (which significantly reducing the ambient image light that propagates through sensing cutout 783 and second sensing cutout 784).

FIG. 7C illustrates a cross section view of viewer 701 through sensing cutout 783, second sensing cutout 784, and sensor 709 when mobile device 702 is folded up against mobile device support surface 786. The cross section view is on a plane that is orthogonal to cutouts 783 and 784. FIG. 7C shows sensing cutout 783 in viewing surface 735 and second sensing cutout 784 in mobile device support surface 786. Image light may propagate through sensing cutout 783 and second sensing cutout 784 to reach sensor 709 along a light path 733.

FIG. 7D illustrates a cross section view of viewer 701 through eye-cutout 124A. The cross section view is on a plane that is orthogonal to eye-cutout 124A. In FIG. 7D, mobile device support surface 786 includes display void 785 that allows a viewer to view display 725. Image light propagates to sensor 709 through first eye-cutout 124A and through any lensing optics 799 that may be included in viewer 701. The image light travels along light path 734 to sensor 709. Sensor 709 is not illustrated in FIG. 7D because it is not in the same plane as the cross section view of FIG. 7D although light path 734 is illustrated as propagating to sensor 709 at angle to the plane of the cross section view of FIG. 7D.

In one embodiment, processing logic 503 is included in a device (e.g. 501) included in viewer 701 and upon a power-up event of the device, the processing logic is configured to sample an image light signal generated by optical sensor 709 and automatically render AR or VR video content (e.g. 589) when the image light signal is a below a pre-determined threshold, where the pre-determined threshold is stored in a memory of the device. A power-up event of the device may include a power button being pressed on the device or a power source (e.g. battery) becoming accessible to the device.

Utilizing the hardware and techniques described in this disclosure, time and physical barriers of AR and/or VR experience can be reduced. In one particular illustrative context, attendees at a conference or trade show can bring a viewer to their face to experience a brief AR and/or VR experience without requiring assistance to navigate to the AR and/or VR experience or time to familiarize themselves with a particular interface. Rather, the AR and/or VR experience can be initiated (and optionally paused) automatically based on the sensing of the disclosed sensors. In another illustrative context, a viewer is placed in a container (e.g. 350) and the recipient of the container can simply raise the viewer to their face to facilitate the AR and/or VR experience.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible non-transitory machine-readable storage medium includes any mechanism that provides (i.e., stores) information in a form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A viewer for viewing Augmented Reality or Virtual Reality content, the viewer comprising:
a display;
processing logic coupled to render images to the display;
memory coupled to the processing logic, wherein video content associated with a virtual reality or augmented reality experience is stored in the memory;
a viewing body for housing the display, the processing logic, and the memory, wherein the viewing body includes a viewing cavity on a viewing side of the viewing body; and
a sensor configured to output a sense signal, wherein the processing logic is configured to automatically render the video content to the display when the sense signal indicates the viewer has been brought to a face of a user, the processing logic coupled to receive the sense signal.

2. The viewer of claim 1, wherein the viewing body includes a viewing surface having a first eye-cutout and a second eye-cutout for viewing the display, and wherein the viewing surface includes a sensing cutout for receiving image light incident upon the viewing cavity,
wherein the sensor includes an optical sensor disposed to receive the image light through the sensing cutout, and wherein the processing logic is configured to automatically render the video content to the display when an image light value included in the sense signal reaches a pre-determined image light threshold, the image light value representing an intensity of the image light incident upon the optical sensor.

3. The viewer of claim 1, wherein the sensor includes a touch-sensitive sensor disposed on a face interface edge that is included in a boundary of the viewing cavity, the touch-sensitive sensor outputting a touch signal included in the sense signal.

4. The viewer of claim 3 further comprising:
a second touch-sensitive sensor disposed on a gripping surface disposed between the viewing side of the viewer that is opposite a scene side of the viewer, wherein the second touch-sensitive sensor outputs a second touch signal, and wherein the processing logic is configured to automatically render the video content when the touch signal and the second touch signal are received by the processing logic contemporaneously.

5. The viewer of claim 1, wherein the viewing body includes a viewing surface having a first eye-cutout and a second eye-cutout for viewing the display, and wherein the viewer further comprises:
lensing optics disposed between the display and the first eye-cutout and second eye-cutout, wherein the sensor includes an optical sensor disposed to receive image light incident upon the viewing cavity, wherein the image light propagates through the lensing optics and at least one of the first eye-cutout or the second eye-cutout prior to being received by the optical sensor.

6. The viewer of claim 1, wherein the processing logic is coupled to pause the video content when the sense signal indicates the viewer has withdrawn the viewer from the face of the user.

7. The viewer of claim 1, wherein the viewing body is attached with a mobile device that includes the display, the processing logic, the memory, and the sensor.

8. The viewer of claim 7, wherein the viewing body includes a mobile device support surface disposed on a parallel plane to a viewing surface having a first eye-cutout and a second eye-cutout for viewing the display, and wherein the viewing surface includes a sensing cutout for receiving image light incident upon the viewing cavity, and further wherein the mobile device support surface has a display void that is larger than the display and smaller than the mobile device, the mobile device support surface including a second sensing cutout,
wherein the sensor includes an optical sensor disposed to receive the image light through the sensing cutout and the second sensing cutout, and wherein the processing logic is configured to automatically render the video content to the display when an image light value included in the sense signal reaches a pre-determined image light threshold, the image light value representing an intensity of the image light incident upon the optical sensor.

9. The viewer of claim 1, wherein the sensor includes an image sensor.

10. A device comprising:
a display;
processing logic coupled to render images to the display;
memory coupled to the processing logic, wherein video content associated with a virtual reality or augmented reality experience is stored in the memory;
a viewing body for housing the display, the processing logic, and the memory, wherein the viewing body includes a viewing cavity on a viewing side of the viewing body; and
an optical sensor configured to output an image light signal, wherein the processing logic is coupled to receive the image light signal, and wherein the processing logic is configured to, upon a power-up event:
sample the image light signal; and
automatically render the video content to the display when the image light signal is below a pre-determined threshold, the pre-determined threshold stored in the memory of the device.

11. The device of claim 10, wherein the optical sensor includes an image sensor.

12. The device of claim 10, wherein the optical sensor includes an infrared proximity sensor.

13. The device of claim 10, wherein the optical sensor and the display are facing a same direction.

14. A computer-implemented method of automatically initiating a virtual reality or augmented reality experience, the method comprising:
receiving, with processing logic included in a viewer, a sense signal indicating that a user has brought a viewing side of the viewer to their eyes, wherein the sense signal was generated by a sensor included in the viewer;
receiving, with the processing logic included in the viewer, a touch signal indicating that the user has touched a side of the viewer, wherein the touch signal was generated by a touch-sensitive sensor disposed on a side of the viewer; and
rendering virtual reality or augmented reality video content on a display of the viewer when the sense signal and the touch signal are received by the processing logic contemporaneously.

15. The computer-implemented method of claim 14, the method further comprising:
pausing the rendering of the video content when the sense signal and the touch signal are not received by the processing logic contemporaneously.

16. The computer-implemented method of claim 14, wherein the sensor includes a second touch-sensitive sensor disposed on a face interface edge that is included in a boundary of a viewing cavity of the viewer.

17. The computer-implemented method of claim 14, wherein the sensor includes an infrared proximity sensor.

18. The computer-implemented method of claim 14, wherein the sensor includes an image sensor.

19. The computer-implemented method of claim 14, wherein the display, the processing logic, and the sensor are included in a mobile device attached with the viewer.
